(19) United States
(12) Patent Application Publication
(10) Pub. No.: US 2015/0104264 A1
(43) Pub. Date: Apr. 16, 2015

(54) DRILLING TOOL

(71) Applicant: Hilti Aktiengesellschaft, Schaan (LI)

(72) Inventors: Andreas Vogel, Muenchen (DE); Taack-Trakranen Van John, Muenchen (DE)

(73) Assignee: Hilti Aktiengesellschaft, Schaan (LI)

(21) Appl. No.: 14/385,933

(22) PCT Filed: Mar. 14, 2013
(86) PCT No.: PCT/EP2013/055190

§ 371 Date: Sep. 17, 2014

(30) Foreign Application Priority Data
Mar. 21, 2012 (DE) 10 2012 204 491.4

(51) Int. Cl. B23B 51/04; B23B 31/113; B28D 1/04; B23B 31/00

(52) U.S. Cl. CPC B23B 51/0473; B23B 31/008; B23B 31/003; B23B 31/113; B28D 1/041; B23B 2226/31; B23B 2226/75
USPC 408/204; 408/226; 279/93; 279/46.7

(57) ABSTRACT

A drilling tool is disclosed. The drilling tool includes a drilling stub, a cutting element attached to the drilling stub, and a fastening section for fastening onto a tool holder. The fastening section is divided into at least one guide region and one locking region, where at least one interlocking geometry, which protrudes in the axial direction beyond the remaining locking region, and which in particular is a bulge, is designed for transmission of a torque from the tool holder to the drilling tool, and the at least one interlocking geometry has two abutting surfaces each in the tangential direction. One first abutting surface of the two abutting surfaces is designed essentially parallel to a longitudinal axis of the drilling tool and the first abutting surface serves to transmit the torque.

This application claims the priority of International Application No. PCT/EP2013/055190, filed Mar. 14, 2013, and German Patent Document No. 10 2012 204 491.4, filed Mar. 21, 2012, the disclosures of which are expressly incorporated by reference herein.

### BACKGROUND AND SUMMARY OF THE INVENTION

The present invention relates to a drilling tool and a tool holder.

Drilling tools, in particular core drilling tools are used for drilling in various materials, e.g., concrete, reinforced concrete, steel or rock. The drilling tool is detachably attached to and/or accommodating in a tool holder, so that the drilling tool can be made to rotate about a longitudinal axis of the drilling tool by means of an electric motor or an internal combustion engine on the tool holder. The tool holder is required to make it possible to drill holes of different diameters using different drilling tools with different diameters. In addition, it is also necessary to replace drilling tools due to wear.

The torque of the rotational movement of the drilling tool is transferred in a force-locking and interlocking manner. A receptacle part and/or a carrier body of the tool holder has/have a recess having a first opposing abutting surface on a rear end, said surface being inclined at an angle of approx. 30° to 45° to a longitudinal axis of the drilling tool and the tool holder. The drilling tool has bulges with a first and second abutting surface on a rear locking surface and the abutting surfaces are inclined at an angle of approx. 30° to 45° to a longitudinal axis of the drilling tool and of the tool holder. In the case of a drilling tool attached to the tool holder, the bulges on the drilling tool are arranged in the recesses in the receptacle part, and the first abutting surface rests on the first opposing abutting surface for transmitting a force from the receptacle part to the drilling tool. Based on the inclination of the first abutting surface and opposing abutting surface, this determines the resulting compressive force acting on the drilling tool, directed at ejecting the drilling tool out of the tool holder, so that a receiving spring on the receptacle part must be designed with large dimensions. Greater compressive forces therefore act on the drilling tool and on the tool holder in a deleterious manner. Contact with the first abutting surface and the opposing abutting surface results in high force peaks and thus abrasive wear phenomena in the case of point contact.

DE 198 10 911 A1 discloses a drilling tool having an insertion end, where the insertion end has an essentially cylindrical guide region having at least one guide surface and one locking region that protrudes radially beyond the guide region, such that the locking region has locking surfaces running essentially at a right angle to the longitudinal axis of the drilling tool and has a cross section that deviates from a circular cross section perpendicular to the longitudinal axis of the drilling tool.

The object of the present invention is therefore to make available a drilling tool and a tool holder with which essentially no axial compressive forces ejecting the drilling tool out of the tool holder are transferred to the drilling tool when a torque is transmitted from the tool holder to the drilling tool.

This object is achieved with a drilling tool comprising a drill stub, a cutting element attached to the drill stub, a fastening section for fastening to a tool holder, such that the fastening section is subdivided into at least one guide region and into one locking region, such that an interlocking geometry, in particular a bulge, which protrudes axially beyond the remaining locking region, is formed on the locking region for transmitting a torque from the tool holder to the drilling tool, and which has at least one interlocking geometry in the tangential direction for two abutting surfaces, such that, of the two abutting surfaces, at least one first abutting surface is formed essentially parallel to a longitudinal axis of the drilling tool, and the at least one first abutting surface serves to transmit the torque.

The at least one first abutting surface of the two abutting surfaces is designed or aligned to be essentially parallel to the longitudinal axis of the drilling tool, i.e., with a deviation of less than 30° , 20° or 10°. In fastening the drilling tool on a tool holder, a compressive force is applied by a first opposing abutting surface to the first abutting surface to transmit a torque from the tool holder to the drilling tool for inducing a rotational movement in the drilling tool. Because of the essentially parallel alignment of the at least one first abutting surface relative to the longitudinal axis of the drilling tool, therefore essentially no resulting compressive forces occur on the at least one first abutting surface and the opposing abutting surface as the resultant of this compressive force, such that the resulting compressive forces are aligned in such a manner that would eject the drilling tool from the tool holder. The compressive forces that occur on the drilling tool as well as on the tool holder can therefore be reduced substantially, and the wear can also be decreased. The resulting compressive forces are therefore very minor or there is essentially no compressive force that could move the drilling tool out of the tool holder, so therefore the receiving spring, which applies a compressive force to the receptacle part and/or to a carrier body, is designed to have substantially smaller dimensions than in the prior art.

In a supplementary variant, the at least one first abutting surface has a greater extent in the axial direction than the at least one second abutting surface of the two abutting surfaces, and/or the at least one first abutting surface is subdivided in the axial direction into an outer abutting partial surface and an inner abutting partial surface, and the at least one inner abutting partial surface, in particular all the inner abutting partial surfaces, is/are designed to be essentially parallel to the longitudinal axis of the drilling tool and/or all the first abutting surfaces are designed to be essentially parallel to a longitudinal axis of the drilling tool.

In one additional specific embodiment, the at least one external abutting partial surface is formed at an acute angle to the longitudinal axis and/or at least two or three interlocking geometries are formed on the drilling tool and/or the at least one interlocking geometry, in particular at least one bulge has an essentially constant extent between the two abutting surfaces in the axial direction. The at least one interlocking geometry, in particular the at least one bulge or recess, is formed between the two abutting surfaces as a flat or planar surface. This is necessary because there is a play or a distance between the two abutting surfaces and the opposing abutting surfaces in an arrangement of the bulge on the drilling tool in a recess on the tool holder, and when a torque is applied, there is therefore relative movement between the flat or planar surface on the two abutting surfaces and a similarly designed flat or planar surface between the two opposing abutting surfaces on the tool holder. The flat or planar surface is preferably aligned essentially perpendicular to the longitudinal axis on the interlocking geometry and/or on the opposing interlocking geometry.

In one additional specific embodiment, at least one, preferably at least two or three locking noses are formed on the locking region and the interlocking geometry is formed on at least one locking nose, in particular on a rear locking surface, facing a rear end of the drilling tool.

In one additional embodiment, the drilling tool is a core drilling tool with a hollow pipe connection as a drilling stud and a cutting ring as a cutting element, and the cutting ring is preferably diamond tipped. Core drilling tools are used in particular for cutting bores in concrete or reinforced concrete.

Tool holders according to the invention for receiving a drilling tool, in particular a drilling tool as described in this patent application, comprising a receptacle part with at least one opposing interlocking geometry, in particular a recess, for interlocking transmission of a torque from the at least one opposing interlocking geometry to an interlocking geometry on the drilling tool, and the at least one opposing interlocking geometry, both have two opposing abutting surfaces in the tangential direction, preferably an ejector for ejecting the drilling tool out of the tool holder, a sleeve surrounding the receptacle part and the ejector, such that at least one first opposing abutting surface of the two opposing abutting surfaces is designed to be essentially parallel to a longitudinal axis of the drilling tool, and the at least one first opposing abutting surface serves to transmit the torque.

The at least one first opposing abutting surface expediently has a greater extent in the axial direction than a second one of the two opposing abutting surfaces and/or the at least one first opposing abutting surface is divided in the axial direction into an outer and an inner opposing abutting surfaces, and the at least one outer opposing abutting partial surface, in particular all of the outer opposing abutting partial surfaces are designed to be essentially parallel to a longitudinal axis of the drilling tool and/or the tool holder and/or all of the first opposing abutting surfaces are designed to be essentially parallel to a longitudinal axis of the drilling tool.

In a supplementary variant, the at least one inner opposing abutting partial surface is designed at an acute angle to the longitudinal axis and/or at least two or three opposing interlocking geometries are formed on the tool holder and/or the at least one opposing interlocking geometry, in particular a recess between the two opposing abutting surfaces has an essentially constant extent in the axial direction.

In one additional specific embodiment, the ejector is designed in the form of a ring and/or the ejector is acted upon by an ejector spring with a compressive force for ejecting the drilling tool out of the tool holder and/or the receptacle part is acted upon by a receiving spring with a compressive force, so that the receptacle part can be placed on a rear locking surface of the drilling tool under a compressive force and/or the tool holder has a bayonet connection for fastening the drilling tool in the tool holder.

In a supplementary variant, the bayonet connection comprises the sleeve, the receptacle part and the receiving spring.

In a supplementary specific embodiment, the interlocking geometry is formed as a recess on the drilling tool, in particular the locking region, and the opposing interlocking geometry is formed as a bulge on the tool holder, in particular on the receptacle part there.

In one additional specific embodiment, the opposing interlocking geometry is designed to be essentially geometrically complementary to the interlocking geometry.

The drilling tool and/or the tool expediently is/are made of metal, in particular steel, at least in part, in particular completely.

A drilling system according to the invention comprises a drilling tool described in this patent application and a tool holder described in this patent application and a drive motor, in particular an electric motor, as well as preferably a standing frame.

In another specific embodiment, the drilling tool is attached to the tool holder on the drilling system.

One exemplary embodiment of the present invention is described in greater detail below with reference to the accompanying drawings.

### BRIEF DESCRIPTION OF THE DRAWINGS

FIG. 1 shows a longitudinal section through a drilling tool,

FIG. 2 shows a tangential section through a recess on a receptacle part of a tool holder known from the prior art,

FIG. 3 shows a tangential section through the recess on the receptacle part of the tool holder according to the invention and a bulge on a locking nose of a drilling tool according to the invention,

FIG. 4 shows a perspective view of the drilling tool according to the invention and the tool receptacle according to the invention,

FIG. 5 shows another perspective view of the drilling tool and the tool receptacle according to FIG. 4,

FIG. 6 shows a front view of the tool receptacle according to FIG. 4,

FIG. 7 shows a longitudinal section X-X through the tool receptacle according to FIG. 6, and

FIG. 8 shows a side view of a drilling system.

### DETAILED DESCRIPTION OF THE DRAWINGS

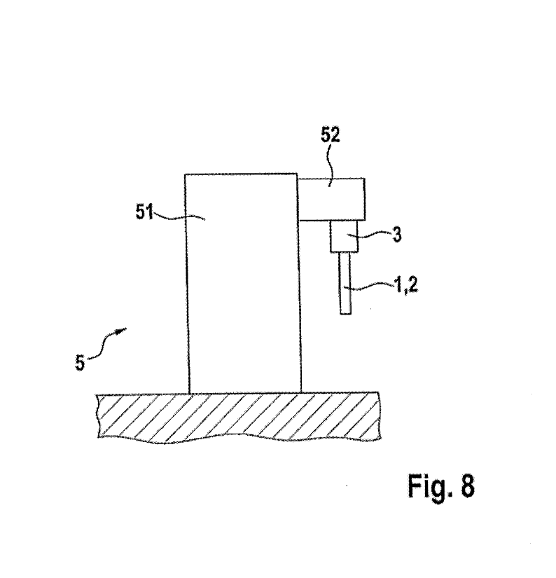

A drilling system 5 shown in FIG. 8 comprises a drilling tool 1 designed as a core drilling tool 2, a tool holder 3 and a drive motor designed as an electric motor 52 as well as a standing frame 51. In deviation from this, the drive motor may also be designed as an internal combustion engine. A core hole can be drilled into a wall, a floor or a ceiling of a building made of reinforced concrete (not shown) by means of the drilling system 5. The standing frame 51 stands immovably on a floor and the electric motor 52 together with the tool holder 3 and the core drilling tool 2 can be advanced by means of a drive device in the direction of a longitudinal axis 4 toward the floor.

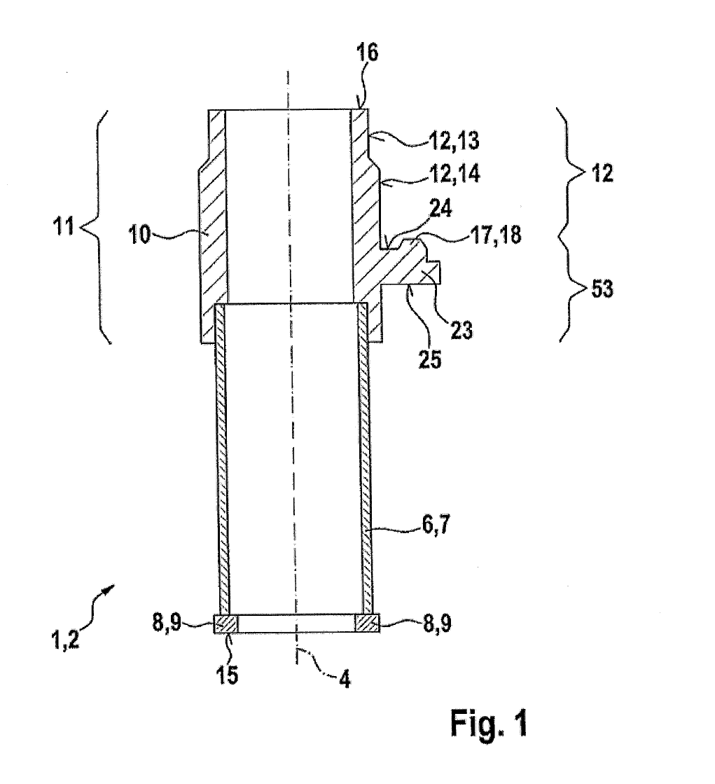

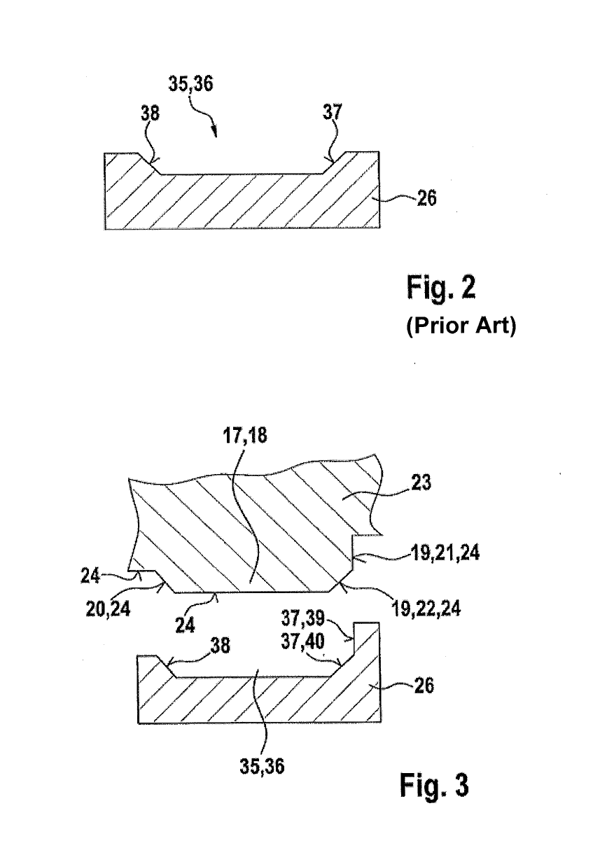

The drilling tool 1 (FIG. 1) comprises a drilling stub 6 designed as a hollow pipe connection 7 and a fastening part 10. The drilling tool 1 thus has a forward end 15 and a rear end 16. A cutting element 8 designed as a cutting ring 9 is attached to the drilling stub 6, and the cutting ring 9 is diamond tipped (not shown). The cutting ring 9 thus forms the forward end 15 of the drilling tool 1 and a core hole is cut in the floor of a building by means of the cutting ring 9.

The fastening part 10 comprises a fastening section 11 with a guide region 12 and a locking region 53 (FIG. 1). The guide region 12 is divided into a first guide region 13 and a second guide region 14, the first guide region 13 having a smaller outside radius or outside diameter than the second guide region 14. Three locking noses 23 (FIGS. 1, 4 and 5) are designed with a rear locking surface 24 and a front locking surface 25 on the locking region 53. An interlocking geometry 17 designed as a bulge 18 is provided on the rear locking surface 24. The bulge 18 has a first abutting surface 19 and a second abutting surface 20 in the tangential direction (FIG. 3). The first abutting surface 19 is divided into an inner abutting partial surface 21 and an outer abutting partial surface 22. The inner abutting partial surface 21 is aligned essentially parallel to a longitudinal axis 4 and the outer abutting partial surface 22 is aligned at an acute angle of essentially 45° to the longitudinal axis 4. The drilling stub 6 and the guide region 12 of the fastening part 10 are designed in the form of a ring in cross section.

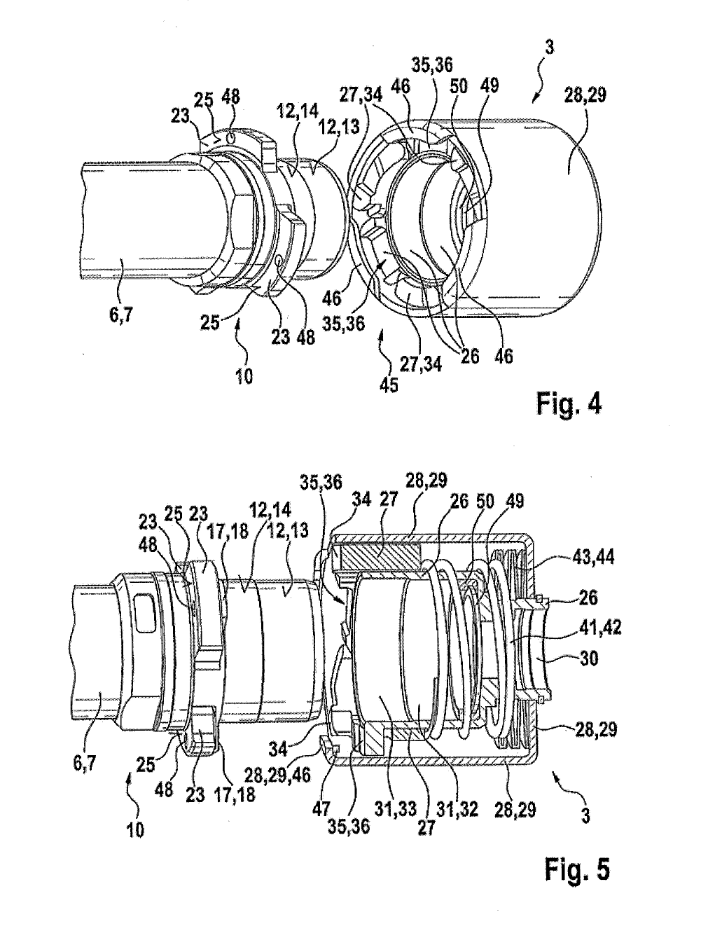

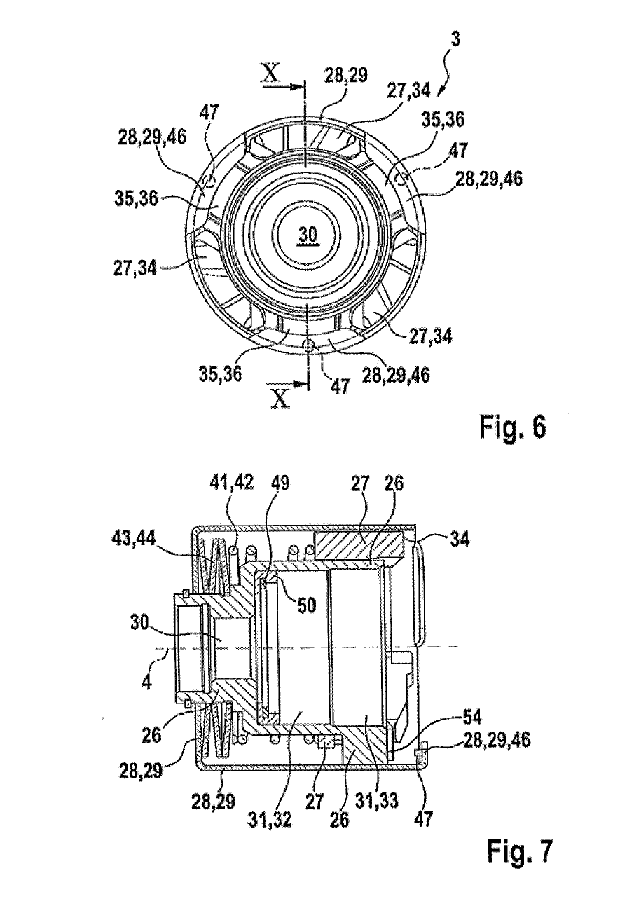

The tool holder 3 (FIGS. 4 through 7) comprises a sleeve 28 which is designed as a tension sleeve 29, a receptacle part 26 and/or a carrier body 26 and a ring-shaped ejector 27 and/or a ring 27. The ejector 27 and the receptacle part 26 made of steel are arranged inside the sleeve 28 made of steel. The ring-shaped ejector 27 is arranged coaxially and/or concentrically inside the sleeve 28 and the receptacle part 26 is arranged coaxially and/or concentrically inside the ejector 27. The receptacle part 26, which is designed essentially with a ring-shaped cross section, has a through-opening 30 with a small diameter on the rear end and on this rear end region of the receptacle part 26 the receptacle part 26 passes through the sleeve 28 (FIGS. 5 and 7). Following the through-opening 30 in the direction of a forward end 54 of the receptacle part 26, the latter has a guide opening 31, which is divided into a first and a second guide opening 32, 33. The second guide opening 33 on the forward end 54 of the receptacle part 26 has a larger inside radius and/or inside diameter than the first guide opening 32. An ejector spring 41 designed as a spiral spring 42 applies a compressive force to the ejector 27 in the direction of the forward end of the ejector 27, i.e., in the direction of a connecting shoulder 34 of the ejector 27. A receiving spring 43, which is designed as a plate spring 44, applies a compressive force to the receptacle part 26 in the direction of the forward end 54 of the receptacle part 26.

On the rear end of the first guide opening 32, there is a holding ring 50 made of steel and a sealing ring 49 made of an elastic material, e.g., rubber, is arranged in an annular groove on the holding ring 50.

On the forward end of the receptacle part 26, three opposing interlocking geometries 35 designed as recesses 36 are provided (FIGS. 3, 4 and 5). The recesses 36 are bordered in the tangential direction by a first opposing abutting surface 37 and a second opposing abutting surface 38. The first opposing abutting surface 37 is divided in the direction of the longitudinal axis 4 into an outer opposing partial abutting surface 39 and an inner opposing partial abutting surface 40 in a manner similar to that with the first abutting surface 19. The inner opposing partial abutting surface 40 is aligned at an acute angle of approx. 45° to the longitudinal axis 4 and the outer opposing partial abutting surface 39 is aligned essentially parallel to the longitudinal axis 4.

In the condition of the tool holder 3 illustrated in FIG. 4, where the drilling tool 1 has been ejected, the stop shoulder 34, as the front axial end of the ejector 27 in the axial direction, is positioned at a shorter distance from three holding arms 46 on the sleeve 28 than the front axial end of the receptacle part 26. The three holding arms 46 are formed on only three subsections in the tangential direction, so that three partial regions of the tension sleeve 29 without the holding arms 26 are formed between the three holding arms 46. To produce the fastening part 10 and connect it to the tool holder 3, the three locking noses 23 are inserted into the subsections between the three holding arms 46. Then the radial outer extent or the outside diameter of the three locking noses 23 is slightly smaller than the inside diameter of the sleeve 28 so that the three locking noses 23 can be inserted inside the tension sleeve 29 and the bulges 18 first come in contact with stop shoulders 34 of the ejector 27 because of the positioning of the three stop shoulder 34 on the ejector 27. Next the ejector 27 is to be moved in the direction toward a rear end of the receptacle part 26 opposite the compressive force applied by the ejector spring 41 to the ejector 27 by applying a compressive force to the stop shoulder 34 in the axial direction. Next the fastening part 10 is to be rotated by approx. 60°, so that the front locking surfaces 25 rest on the holding arms 46 and the rear locking surfaces 24 rest on the forward end of the receptacle part 26. In this rotational angle position, the bulges 18 on the fastening part 10 are disposed inside the recesses 36 of the receptacle part 26. Furthermore, locking cams 47 formed on the holding arms 46 on the inside in the axial direction are arranged within axial locking bores 48 on the locking noses 23. When the fastening part 10 is rotated, thus the fastening part 10 is moved in the direction of the forward end 15 of the drilling tool 1 after being rotated by approx. 60° in the axial direction, because the locking cam 47 engages in the locking bores 48 because of the compressive force on the fastening part 10 applied by the stop shoulders 34 and the forward end of the receptacle part 26. The fastening part 10 is thus secured in a twist-proof manner in the tool holder 3 by means of the locking cams 47 and the locking bores 48, thus forming a bayonet connection 45 between the fastening part 10 and the tool holder 3.

To eject the drilling tool 1 out of the tool holder 3, an axial compressive force is to be applied to the drilling tool 1 in the direction toward the rear end of the receptacle part 26, so that the fastening part 10 is moved opposite the compressive force, acting in the direction of the rear end of the ejector 27, applied to the fastening part 10 by the stop shoulder 34 on the ejector 27 and the rear end of the ejector 27, and the receptacle 26 and the ejector 27 are thereby also moved in the axial direction toward the rear so that in this way the locking cams 47 can be moved out of the locking bores 48 and then a rotational movement of the fastening part 10 by approx. 60° is possible so that the locking noses 23 can therefore be moved out of the intermediate spaces between the holding arms 46 back out of the sleeve 28.

The rear end of the receptacle part 26 is connected to the electric motor 52 on the drilling system 5. To apply a torque to the drilling tool 1 by means of the electric motor 52, a compressive force is applied to the inner abutting partial surfaces 21 and the bulges 18 by outer opposing partial abutting surfaces 39 on the recesses 36. This compressive force is transferred essentially only by the inner abutting partial surfaces 21 and the outer opposing partial abutting surfaces 39 because of the geometry of the bulges 18 and the recesses 36 because in the event of contact between the inner abutting partial surfaces 21 and the outer opposing partial abutting surfaces 39, there is essentially no contact between the inner opposing partial abutting surfaces 40 and the outer abutting partial surfaces 22. Furthermore, the distance between the first and second opposing partial abutting surfaces 37, 38 is greater than the distance between the first and second abutting surfaces 19, 20 in the tangential direction. In the transmission of a torque from the outer abutting partial surfaces 39 as compressive force acting on the inner abutting partial surfaces 21, no axial compressive force is thus applied to the fastening part 10 and thus to the drilling tool 1, so this does not result in any compressive force acting on the receptacle part 26 and therefore the receiving spring 43 need essentially apply only an adequate compressive force to the fastening part 10, so that the locking cams 47 are securely arranged inside the locking bores 48 during operation.

When considered on the whole, essential advantages are associated with the drilling tool 1 according to the invention and the tool holder 3 according to the invention. The transmission of the torque from the receptacle part 26 to the fastening part 10 of the drilling tool 1 causes essentially no axial compressive forces on the fastening part 10 and/or the receptacle part 26, so that the receiving spring 43 can therefore be designed with smaller dimensions and thus only minor compressive forces need be overcome in the axial movement of the receptacle part 26 to establish the connection between the fastening part 10 and the tool holder 3. In addition, this also makes it possible to reduce wear phenomena.

1.-10. (canceled)

11. A drilling tool, comprising:
a drilling stub;
a cutting element attached to the drilling stub;
a fastening section for fastening onto a tool holder, wherein the fastening section is divided into a guide region and a locking region; and
an interlocking geometry protruding in an axial direction on the locking region, wherein the interlocking geometry has a first abutting surface and a second abutting surface in a tangential direction;
wherein the first abutting surface is essentially parallel to a longitudinal axis of the drilling tool and wherein a torque is transmittable from the tool holder to the drilling tool via the first abutting surface.

12. The drilling tool according to claim 10, wherein the interlocking geometry is a bulge.

13. The drilling tool according to claim 10, wherein the first abutting surface has a greater extent in the axial direction than the second abutting surface.

14. The drilling tool according to claim 10, wherein the first abutting surface is divided in the axial direction into an outer abutting surface and an inner abutting surface and wherein the inner abutting surface is essentially parallel to the longitudinal axis of the drilling tool.

15. The drilling tool according to claim 14, wherein the outer abutting surface is disposed at an acute angle to the longitudinal axis.

16. The drilling tool according to claim 10, wherein the interlocking geometry has an essentially constant extent in the axial direction between the first and the second abutting surfaces.

17. The drilling tool according to claim 10, wherein a locking nose is formed on the locking region and wherein the interlocking geometry is formed on the locking nose on a rear locking surface which faces a rear end of the drilling tool.

18. The drilling tool according to claim 10, wherein the drilling tool is a core drilling tool with a hollow pipe connection as the drilling stub and a cutting ring as the cutting element and wherein the cutting ring includes diamonds.

19. A tool holder for receiving a drilling tool, comprising:
a receptacle part with an interlocking geometry, wherein a torque is transmittable by the interlocking geometry to an interlocking geometry on the drilling tool and wherein the interlocking geometry has a first abutting surface and a second abutting surface in a tangential direction;
an ejector, wherein the drilling tool is ejectable out of the tool holder by the ejector; and
a sleeve surrounding the receptacle part;
wherein the first abutting surface is essentially parallel to a longitudinal axis of the drilling tool and wherein the torque is transmittable by the first abutting surface.

20. The tool holder according to claim 19, wherein the interlocking geometry is a recess.

21. The tool holder according to claim 19, wherein the first abutting surface has a greater extent in an axial direction than the second abutting surface.

22. The tool holder according to claim 19, wherein the first abutting surface is divided in an axial direction into an outer abutting surface and an inner abutting surface and wherein the outer abutting surface is essentially parallel to the longitudinal axis of the drilling tool and/or the tool holder.

23. The tool holder according to claim 22, wherein the inner abutting surface is disposed at an acute angle to the longitudinal axis.

24. The tool holder according to claim 19, wherein the interlocking geometry has an essentially constant extent in an axial direction between the first and the second abutting surfaces.

25. The tool holder according to claim 19, wherein the ejector is in a form of a ring.

26. The tool holder according to claim 19, wherein the ejector is acted upon by an ejector spring with a compressive force for ejecting the drilling tool out of the tool holder.

27. The tool holder according to claim 19, wherein the receptacle part is acted upon by a receiving spring with a compressive force such that the receptacle part is placeable on a rear locking surface of the drilling tool under a compressive force.

28. The tool holder according to claim 19, wherein the tool holder has a bayonet connection and wherein the drilling tool is fastenable in the tool holder by the bayonet connection.

29. The tool holder according to claim 28, wherein the bayonet connection is comprised of the sleeve, the receptacle part, and the receiving spring.
